(19) United States
(12) Patent Application Publication
(10) Pub. No.: US 2022/0025145 A1
(43) Pub. Date: Jan. 27, 2022

(54) CLOSED CELL FOAM AND ASSOCIATED EXPANDABLE COMPOSITION, FOAM-FORMING PROCESS, AND ARTICLE

(71) Applicant: SHPP GLOBAL TECHNOLOGIES B.V., Bergen op Zoom (NL)

(72) Inventors: Erin DIKEMAN, Pittsfield, MA (US); Thomas P. GRECO, Pittsfield, MA (US); Scott SIMPSON, Pittsfield, MA (US); Jon M. GIRARD, Pittsfield, MA (US)

(21) Appl. No.: 17/311,781

(22) PCT Filed: Dec. 11, 2019
(86) PCT No.: PCT/US2019/065623

§ 371 Date: Jun. 8, 2021

(30) Foreign Application Priority Data
Dec. 14, 2018 (EP) 18212709.2

(51) Int. Cl. C08J 9/14; C08G 73/10; C08J 9/00

(52) U.S. Cl. CPC C08J 9/142; C08G 73/1046; C08J 9/0066; C08J 2201/03; C08J 2203/182; C08J 2203/12; C08J 2205/052; C08J 2379/08

(57) ABSTRACT

A polyetherimide-based foam contains specific amounts of a nucleating agent and a polyetherimide having a weight average molecular weight of 30,000 to 80,000 grams per mole and a dispersity of 2.7 to 4.5. The foam has a density of 20 to 60 kilograms per meter3, and a closed cell content of 80 to 100 percent. The foam can be prepared by a method that combines the nucleating agent and polyetherimide with a blowing agent that includes specific amounts of acetone and methanol. Also described are articles that include the foam.

### BACKGROUND OF THE INVENTION

Polyetherimides are high-performance polymers prized for their high heat resistance, solvent resistance, flame resistance, and low moisture absorption. Polyetherimides have been used to form rigid foams that provide a high strength-to-weight ratio. Some uses of polyetherimides require closed cell foams. For example foams used with low viscosity adhesives in resin transfer molding need a high closed cell content to prevent the foam from gaining weight by absorbing the adhesive. However, it can be difficult to prepare a polyetherimide foam having a high closed cell content, particularly in a continuous process.

### BRIEF SUMMARY OF EMBODIMENTS OF THE INVENTION

One embodiment is a polyetherimide-based foam, comprising: 96 to 99.8 parts by weight of a polyetherimide having a weight average molecular weight of 30,000 to 80,000 grams per mole and a dispersity of 2.7 to 4.5, determined by gel permeation chromatography using polystyrene standards; and 0.2 to 4 parts by weight of a nucleating agent; wherein parts by weight are based on 100 parts by weight total of the polyetherimide and the nucleating agent; wherein the polyetherimide-based foam has a density of 20 to 60 kilograms per meter³ determined at 23° C. according to ASTM D1622-14; and wherein the polyetherimide-based foam has a closed cell content of 80 to 100 percent, determined according to ASTM D6226-15.

Another embodiment is an article comprising the polyetherimide-based foam in any of the variations described herein.

Another embodiment is an expandable polyetherimide composition, comprising: 96 to 99.8 parts by weight of a polyetherimide having a weight average molecular weight of 30,000 to 80,000 grams per mole and a dispersity of 2.7 to 4.5, determined by gel permeation chromatography using polystyrene standards; 0.2 to 4 parts by weight of a nucleating agent; 4.1 to 7 parts by weight of a blowing agent comprising 4 to 6 parts by weight acetone and 0.1 to 1 part by weight methanol; wherein all parts by weight are based on 100 parts by weight total of the polyetherimide and the nucleating agent.

Another embodiment is a method of forming a polyetherimide-based foam, comprising: forming an expandable composition by melt blending 96 to 99.8 parts by weight of a polyetherimide having a weight average molecular weight of 30,000 to 80,000 grams per mole and a dispersity of 2.7 to 4.5, determined by gel permeation chromatography using polystyrene standards, 0.2 to 4 parts by weight of a nucleating agent, and 4.1 to 7 parts by weight of a blowing agent comprising 4 to 6 parts by weight acetone and 0.1 to 1 part by weight methanol, wherein all parts by weight are based on 100 parts by weight total of the polyetherimide and the nucleating agent; and extruding the expandable composition through a die to form a polyetherimide-based foam having a density of 20 to 60 kilograms per meter³ determined at 23° C. according to ASTM D1622-14, and a closed cell content of 80 to 100 percent, determined according to ASTM D6226-15; wherein the extruding comprises maintaining a die melt temperature of 190 to 235° C., and a mass flux ratio of 0.035 to 0.065, wherein mass flux ratio is defined as a ratio of mass flux after the die to mass flux before the die.

These and other embodiments are described in detail below.

### BRIEF DESCRIPTION OF THE DRAWING

FIG. 1 is a schematic illustration of a foam extrusion apparatus.

FIG. 2 is a schematic illustration of a cross section of the outlet portion of a die in a foam extrusion apparatus.

### DETAILED DESCRIPTION OF THE INVENTION

The present inventors have determined that a polyetherimide-based foam having a density of 20 to 60 kilograms per meter³ and a closed cell content of 80 to 100 percent can be prepared by a method that starts with a polyetherimide having specific molecular weight characteristics, a nucleating agent, and a blowing agent that includes acetone and methanol. These components, used in specific amounts, are combined to form an expandable composition, which is then extruded through a die at specific temperature and mass flux conditions to form the polyetherimide-based foam.

One embodiment is a polyetherimide-based foam, comprising: 96 to 99.8 parts by weight of a polyetherimide having a weight average molecular weight of 30,000 to 80,000 grams per mole and a dispersity of 2.7 to 4.5, determined by gel permeation chromatography using polystyrene standards; and 0.2 to 4 parts by weight of a nucleating agent; wherein parts by weight are based on 100 parts by weight total of the polyetherimide and the nucleating agent; wherein the polyetherimide-based foam has a density of 20 to 60 kilograms per meter³ determined at 23° C. according to ASTM D1622-14; and wherein the polyetherimide-based foam has a closed cell content of 80 to 100 percent, determined according to ASTM D6226-15.

The polyetherimide-based foam comprises a polyetherimide. A polyetherimide is a polymer comprising etherimide units having the formula

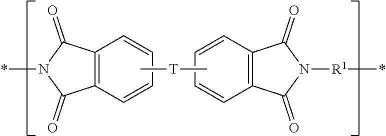

wherein T is —O— or a group of the Formula —O—Z—O— wherein the divalent bonds of the —O— or the —O—Z—O— group are in the 3,3′, 3,4′, 4,3′, or the 4,4′ positions of the phthalimide groups; Z includes divalent moieties of the formula

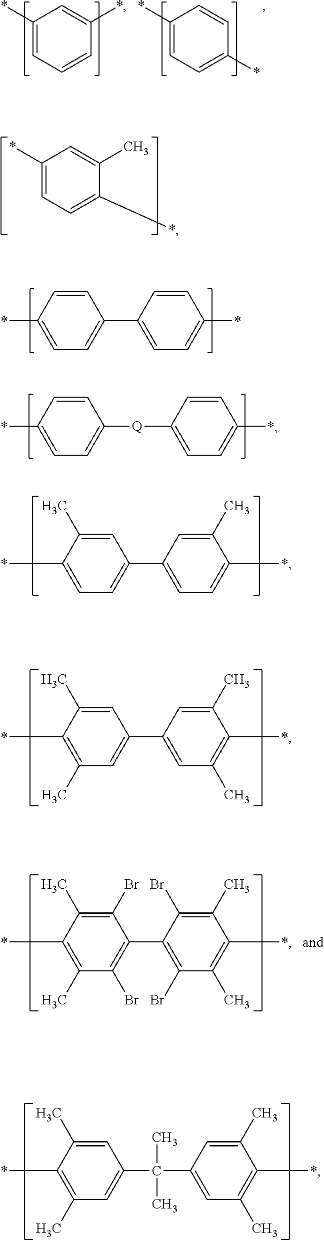

wherein Q is a divalent moiety that can be —O—, —S—, —C(O)—, —SO₂—, —SO—, —C_{y}H_{2y}— wherein y is 1 to 8, or —CₚH_{q}Fᵣ— wherein p is 1 to 8 and q is 0 to 15 and r is 1 to 16 and q+r=2p; and R¹ is independently at each occurrence a divalent group selected from the group consisting of substituted or unsubstituted divalent aromatic hydrocarbon moieties having 6 to 20 carbons, straight or branched chain alkylene moieties having 2 to 20 carbons, cycloalkylene moieties having 3 to 20 carbon atom, and divalent moieties of the general formula

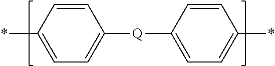

wherein Q is defined above. As used herein, “substituted” means including at least one substituent such as a halogen (i.e., F, Cl, Br, I), hydroxyl, amino, thiol, carboxyl, carboxylate, amide, nitrile, sulfide, disulfide, nitro, C₁-C₁₈ alkyl, C₁-C₁₈ alkoxyl, C₆-C₁₈ aryl, C₆-C₁₈ aryloxyl, C₇-C₁₈ alkylaryl, or C₇-C₁₈alkylaryloxyl. In some embodiments, the polyetherimide is free of halogens. In some embodiments, the polyetherimide comprises etherimide units having the structure

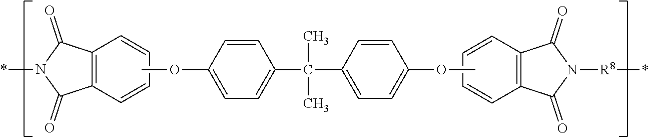

wherein R⁸ is meta-phenylene or para-phenylene. In some embodiments, the polyetherimide comprises poly[2,2-bis(4-(3,4-dicarboxyphenoxy)phenyl)propane)-1,3-phenylene bisimide]. The number of etherimide units in the polyetherimide can be, for example, 10 to 1,000, or 20 to 500.

The polyetherimide has a weight average molecular weight of 30,000 to 80,000 grams per mole, determined by gel permeation chromatography using polystyrene standards. Within this range, the weight average molecular weight can be 45,000 to 80,000 grams per mole, or 55,000 to 75,000 grams per mole. The polyetherimide also has a dispersity of 2.7 to 4.5, determined by gel permeation chromatography using polystyrene standards. Dispersity, formerly known as polydispersity index, is the ratio of weight average molecular weight to number average molecular weight. Within the range of 2.7 to 4.5, the dispersity can be 2.8 to 4.3, or 3 to 4.

Polyetherimides having the desired molecular weight characteristics can be prepared according to procedures described in International Patent Application Publication Number WO 2005/021599 A1 of Khouri et al., published 10 Mar. 2005.

The polyetherimide-based foam comprises the polyetherimide in an amount of 96 to 99.8 parts by weight, based on 100 parts by weight total of the polyetherimide and the nucleating agent. Within this range, the polyetherimide content of the polyetherimide-based foam can be 98 to 99.5 parts by weight.

In addition to the polyetherimide, the polyetherimide-based foam comprises a nucleating agent. Suitable nucleating agents include metallic oxides (including titanium dioxide), clays, talc, silicates, silica, aluminates, barites, titanates, borates, nitrides, and combinations thereof. In some embodiments, the nucleating agent comprises talc.

The polyetherimide-based foam comprises the nucleating agent in an amount of 0.2 to 4 parts by weight, based on 100 parts by weight total of the polyetherimide and the nucleating agent. Within this range, the nucleating agent content of the polyetherimide-based foam can be 0.3 to 3 parts by weight, or 0.5 to 2 parts by weight.

The polyetherimide-based foam has a density of 20 to 60 kilograms per meter³, determined at 23° C. according to ASTM D1622-14. Within this range, the density can be 25 to 55 kilograms per meter³, or 30 to 50 kilograms per meter³.

The polyetherimide-based foam has a closed cell content of 80 to 100 percent, determined according to ASTM D6226-15. Within this range, the closed cell content can be 84 to 100 percent, or 87 to 100 percent.

In some embodiments, the polyetherimide has a complex viscosity of 4300 to 5300 Pascal-seconds, determined according to ASTM D4440-15 at 340° C. and an angular frequency of 1 radian/second. Within this range, the complex viscosity can be 4400 to 5200 Pascal-seconds, or 4500 to 5000 Pascal-seconds.

In a specific embodiment, the polyetherimide-based foam comprises 98 to 99.5 parts by weight of the polyetherimide and 0.5 to 2 parts by weight of the nucleating agent; the polyetherimide has a weight average molecular weight of 55,000 to 75,000 grams per mole and a dispersity of 2.8 to 4.3; the nucleating agent comprises talc; and the polyetherimide-based foam has a density of 30 to 50 kilograms per meter³, and a closed cell content of 87 to 100 percent.

Another embodiment is an article comprising the polyetherimide-based foam in any of its above-described variations. Such articles include components employed in the interiors of vehicles including automobiles, aircraft, ships, trains, and subway cars. A specific article is aerospace interior paneling.

In a specific embodiment of the article, the polyetherimide-based foam comprises 98 to 99.5 parts by weight of the polyetherimide and 0.5 to 2 parts by weight of the nucleating agent; the polyetherimide has a weight average molecular weight of 55,000 to 75,000 grams per mole and a dispersity of 2.8 to 4.3; the nucleating agent comprises talc; and the polyetherimide-based foam has a density of 30 to 50 kilograms per meter³, and a closed cell content of 87 to 100 percent.

Another embodiment is an expandable polyetherimide composition, comprising: 96 to 99.8 parts by weight of a polyetherimide having a weight average molecular weight of 30,000 to 80,000 grams per mole and a dispersity of 2.7 to 4.5, determined by gel permeation chromatography using polystyrene standards; 0.2 to 4 parts by weight of a nucleating agent; and 4.1 to 7 parts by weight of a blowing agent comprising 4 to 6 parts by weight acetone and 0.1 to 1 part by weight methanol; wherein all parts by weight are based on 100 parts by weight total of the polyetherimide and the nucleating agent.

Within the range of 96 to 99.8 parts by weight, the polyetherimide content of the expandable polyetherimide composition can be 98 to 99.5 parts by weight. Within the range of 0.2 to 4 parts by weight, the nucleating agent content of the expandable polyetherimide composition can be 0.5 to 2 parts by weight. Within the range of 4.1 to 7 parts by weight, the blowing agent content of the expandable polyetherimide composition can be 4.65 to 6.1 parts by weight. Within the range of 4 to 6 parts by weight, the acetone content of the expandable polyetherimide composition can be 4.5 to 5.5 parts by weight. Within the range of 0.1 to 1 part by weight, the methanol content of the expandable polyetherimide composition can be 0.15 to 0.6 part by weight.

In a specific embodiment of the expandable polyetherimide composition, the expandable polyetherimide composition comprises 98 to 99.5 parts by weight of the polyetherimide, 0.5 to 2 parts by weight of the nucleating agent, and 4.65 to 6.1 parts by weight of the blowing agent comprising 4.5 to 5.5 parts by weight acetone and 0.15 to 0.6 parts by weight methanol; the polyetherimide has a weight average molecular weight of 55,000 to 75,000 grams per mole and a dispersity of 2.8 to 4.3; and the nucleating agent comprises talc.

Another embodiment is a method of forming a polyetherimide-based foam, comprising: forming an expandable composition by melt blending 96 to 99.8 parts by weight of a polyetherimide having a weight average molecular weight of 30,000 to 80,000 grams per mole and a dispersity of 2.7 to 4.5, determined by gel permeation chromatography using polystyrene standards, 0.2 to 4 parts by weight of a nucleating agent, and 4.1 to 7 parts by weight of a blowing agent comprising 4 to 6 parts by weight acetone and 0.1 to 1 part by weight methanol, wherein all parts by weight are based on 100 parts by weight total of the polyetherimide and the nucleating agent; and extruding the expandable composition through a die to form a polyetherimide-based foam having a density of 20 to 60 kilograms per meter³ determined at 23° C. according to ASTM D1622-14, and a closed cell content of 80 to 100 percent, determined according to ASTM D6226-15; wherein the extruding comprises maintaining a die melt temperature of 190 to 235° C., and a mass flux ratio of 0.035 to 0.065, wherein mass flux ratio is defined as a ratio of mass flux after the die to mass flux before the die.

The method comprises extruding the expandable composition through a die to form the polyetherimide-based foam. During the extruding, a die melt temperature of 190 to 235° C. is maintained. As used herein, “die melt temperature” is the melt temperature of the expandable composition within the die. In some embodiments, the die melt temperature is 195 to 230° C. Extrusion is further characterized by a mass flux ratio of 0.035 to 0.065. Mass flux ratio, which is unitless, is defined as the ratio of mass flux after the die to mass flux before the die. For example, for a process producing foam having a density of 40 kilogram/meter³ and operating at a line speed of 1.1 meter/minute, a line feed rate of 2.75 kilograms/minute, a die gap height of 0.0035 meter and a die gap width of 0.8 meter,

Mass flux after die (kg/(m²−minute))=line speed (m/minute)×density (kg/m³)=1.1 m/minute×40 kg/meter³=44 kg/(m²−minute)

and

Mass flux before die (kg/(m²−minute))=line feed rate (kg/minute)÷die gap area (m²)=2.75 kg/minute÷(0.0035 m×0.8 m)=982 kg/(m²−minute)

and

Mass flux ratio=Mass flux after die (kg/(m²−minute))÷Mass flux before die (kg/(m²−minute))=44 kg/(m²−minute)'982 kg/(m²−minute)=0.045.

Within the range of 96 to 99.8 parts by weight, the polyetherimide content of the expandable composition can be 98 to 99.5 parts by weight. Within the range of 30,000 to 80,000 grams per mole, the polyetherimide weight average molecular weight can be 55,000 to 75,000 grams per mole. Within the range of 2.7 to 4.5, the polyetherimide dispersity can be 2.8 to 4.3, or 3 to 4. Within the range of 0.2 to 4 parts by weight, the nucleating agent content of the expandable composition can be 0.5 to 2 parts by weight. Within the range of 4.1 to 7 parts by weight, the blowing agent content of the expandable composition and be 4.65 to 6.1 parts by weight. Within the range of 4 to 6 parts by weight, the acetone content of the expandable composition can be 4.5 to 5.5 parts by weight. Within the range of 0.1 to 1 part by weight, the methanol content of the expandable composition can be 0.15 to 0.6 part by weight. Within the range of 20 to 60 kilograms per meter³, the density of the polyetherimide-based foam can be 30 to 50 kilograms per meter³. Within the range of 80 to 100 percent, the closed cell content of the polyetherimide-based foam can be 87 to 100 percent, or 90 to 100 percent.

In some embodiments, the method of forming a polyetherimide-based foam is conducted at a line speed of 0.7 to 1.3 meters/minute, or 0.9 to 1.3 meters/minute, or 1 to 1.3 meters/minute. In some embodiments, extruding the expandable composition is conducted through a die having a die lip angle of 20 to 40 degrees. See the working examples below for illustration and discussion of die lip angle. The die can, optionally, be characterized by a die outlet gap in the dimension corresponding to foam thickness. In some embodiments, the die outlet gap is constant across the width of the die outlet. In other embodiments, the die outlet gap is slightly less in the center of the die outlet width relative to the edges of the die outlet width. It has been observed that such variation of the die outlet gap can provide a foam sheet with more uniform density across the width of the sheet.

In a specific embodiment of the method of forming a polyetherimide-based foam, the expandable composition comprises 98 to 99.5 parts by weight of the polyetherimide, 0.5 to 2 parts by weight of the nucleating agent, and 4.65 to 6.1 parts by weight of the blowing agent comprising 4.5 to 5.5 parts by weight acetone and 0.15 to 0.6 parts by weight methanol; the polyetherimide has a weight average molecular weight of 55,000 to 75,000 grams per mole and a dispersity of 2.8 to 4.3; the nucleating agent comprises talc; and the polyetherimide-based foam has a density of 30 to 50 kilograms per meter³, and a closed cell content of 87 to 100 percent.

All ranges disclosed herein are inclusive of the endpoints, and the endpoints are independently combinable with each other. Each range disclosed herein constitutes a disclosure of any point or sub-range lying within the disclosed range.

The invention includes at least the following aspects.

Aspect 1: A polyetherimide-based foam, comprising: 96 to 99.8 parts by weight of a polyetherimide having a weight average molecular weight of 30,000 to 80,000 grams per mole and a dispersity of 2.7 to 4.5 determined by gel permeation chromatography using polystyrene standards; and 0.2 to 4 parts by weight of a nucleating agent; wherein parts by weight are based on 100 parts by weight total of the polyetherimide and the nucleating agent; wherein the polyetherimide-based foam has a density of 20 to 60 kilograms per meter³ determined at 23° C. according to ASTM D1622-14; and wherein the polyetherimide-based foam has a closed cell content of 80 to 100 percent, determined according to ASTM D6226-15.

Aspect 2: The polyetherimide-based foam of aspect 1, wherein the polyetherimide comprises poly[2,2-bis(4-(3,4-dicarboxyphenoxy)phenyl)propane)-1,3-phenylene bisimide].

Aspect 3: The polyetherimide-based foam of aspect 1 or 2, wherein the nucleating agent comprises talc.

Aspect 4: The polyetherimide-based foam of any one of aspects 1-3, having a closed cell content of 87 to 100 percent.

Aspect 5: The polyetherimide-based foam of any one of aspects 1-4, wherein the polyetherimide has a complex viscosity of 4300 to 5300 Pascal-seconds, determined according to ASTM D4440-15 at 340° C. and an angular frequency of 1 radian/second.

Aspect 6: The polyetherimide-based foam of aspect 1, wherein the polyetherimide-based foam comprises 98 to 99.5 parts by weight of the polyetherimide and 0.5 to 2 parts by weight of the nucleating agent; wherein the polyetherimide has a weight average molecular weight of 55,000 to 75,000 grams per mole and a dispersity of 2.8 to 4.3; wherein the nucleating agent comprises talc; and wherein the polyetherimide-based foam has a density of 30 to 50 kilograms per meter³, and a closed cell content of 87 to 100 percent.

Aspect 7: An article comprising the polyetherimide-based foam of any one of aspects 1-6.

Aspect 8: The article of aspect 7, comprising the polyetherimide-based foam of aspect 6.

Aspect 9: The article of aspect 7 or 8, wherein the article is aerospace interior paneling.

Aspect 10: An expandable polyetherimide composition, comprising: 96 to 99.8 parts by weight of a polyetherimide having a weight average molecular weight of 30,000 to 80,000 grams per mole and a dispersity of 2.7 to 4.5, determined by gel permeation chromatography using polystyrene standards; 0.2 to 4 parts by weight of a nucleating agent; 4.1 to 7 parts by weight of a blowing agent comprising 4 to 6 parts by weight acetone and 0.1 to 1 part by weight methanol; wherein all parts by weight are based on 100 parts by weight total of the polyetherimide and the nucleating agent.

Aspect 11: The expandable polyetherimide composition of aspect 10, wherein the expandable polyetherimide composition comprises 98 to 99.5 parts by weight of the polyetherimide, 0.5 to 2 parts by weight of the nucleating agent, and 4.65 to 6.1 parts by weight of the blowing agent comprising 4.5 to 5.5 parts by weight acetone and 0.15 to 0.6 parts by weight methanol; wherein the polyetherimide has a weight average molecular weight of 55,000 to 75,000 grams per mole and a dispersity of 2.8 to 4.3; and wherein the nucleating agent comprises talc.

Aspect 12: A method of forming a polyetherimide-based foam, comprising: forming an expandable composition by melt blending 96 to 99.8 parts by weight of a polyetherimide having a weight average molecular weight of 30,000 to 80,000 grams per mole and a dispersity of 2.7 to 4.5, determined by gel permeation chromatography using polystyrene standards, 0.2 to 4 parts by weight of a nucleating agent, and 4.1 to 7 parts by weight of a blowing agent comprising 4 to 6 parts by weight acetone and 0.1 to 1 part by weight methanol, wherein all parts by weight are based on 100 parts by weight total of the polyetherimide and the nucleating agent; and extruding the expandable composition through a die to form a polyetherimide-based foam having a density of 20 to 60 kilograms per meter³ determined at 23° C. according to ASTM D1622-14, and a closed cell content of 80 to 100 percent, determined according to ASTM D6226-15; wherein the extruding comprises maintaining a die melt temperature of 190 to 235° C., and a mass flux ratio of 0.035 to 0.065, wherein mass flux ratio is defined as a ratio of mass flux after the die to mass flux before the die.

Aspect 13: The method of aspect 12, wherein the expandable composition comprises 98 to 99.5 parts by weight of the polyetherimide, 0.5 to 2 parts by weight of the nucleating agent, and 4.65 to 6.1 parts by weight of the blowing agent comprising 4.5 to 5.5 parts by weight acetone and 0.15 to 0.6 parts by weight methanol; wherein the polyetherimide has a weight average molecular weight of 55,000 to 75,000 grams per mole and a dispersity of 2.8 to 4.3; wherein the nucleating agent comprises talc; and wherein the polyetherimide-based foam has a density of 30 to 50 kilograms per meter³, and a closed cell content of 87 to 100 percent.

The invention is further illustrated by the following non-limiting examples.

### EXAMPLES

Materials used in these examples are summarized in Table 1. Polyetherimides designated PEI 1 and PEI 2 can be prepared according to procedures described in International Patent Application Publication Number WO 2005/021599 A1 of Khouri et al., published 10 Mar. 2005.

TABLE 1

| Material | Description |
|---|---|
| PEI 1 | Poly[2,2-bis(4-(3,4-dicarboxyphenoxy)phenyl)propane)-1,3- |
| | phenylene bisimide], CAS Reg. No. 61128-46-9, having a |
| | weight average molecular weight of 47,000 and a dispersity of |
| | 2.3. |
| PEI 2 | Poly[2,2-bis(4-(3,4-dicarboxyphenoxy)phenyl)propane)-1,3- |
| | phenylene bisimide], CAS Reg. No. 61128-46-9, having a |
| | weight average molecular weight of 63,700 and a dispersity of |
| | 3.4. |
| PEI 3 | Poly[2,2-bis(4-(3,4-dicarboxyphenoxy)phenyl)propane)-1,3- |
| | phenylene bisimide], CAS Reg. No. 61128-46-9, having a |
| | melt volume flow rate of 13 centimeter³/10 minutes |
| | determined according to ISO 1133; obtained as ULTEM ™ |
| | 1000 resin from SABIC. |
| Acetone | Acetone, CAS Reg. No. 67-64-1; obtained from Honeywell. |
| Methanol | Methanol, CAS Reg. No. 67-56-1; obtained from Colonial |
| | Chemical Solutions, Inc. |
| Talc | Talc, CAS Reg. No. 14807-96-6, having a median particle |
| | size less than 0.9 micrometer; obtained as ULTRATALC ™ |
| | 609 from The Cary Company. |

Complex viscosities as a function of frequency were determined for PEI 2 and PEI 3 as follows. Dynamic oscillatory frequency sweeps were run using an ARES strain controlled rheometer from TA Instruments. The frequency sweep method was used to determine the complex viscosity and dynamic modulus of the material as a function of frequency at a constant temperature. The measurements were performed using a 25 millimeter parallel-plate geometry at a 10% strain with a fixed gap of 1 millimeter. The test temperature was 340° C. and frequency was varied from 0.3 to 300 radians/second. Complex viscosity at 1 radian/second was 4625.3 Pascal-seconds for PEI 2, and 4197.7 Pascal-seconds for PEI 3.

Foam boards were produced by a continuous extrusion process using polyetherimide as a base resin, talc particles as a nucleating agent, and a mixture of acetone and methanol as a blowing agent. Polyetherimide (either PEI 1 or PEI 2, specified in Table 2; 99.15 parts by weight) was pre-blended with talc (0.85 parts by weight) in an extruder to form a PEI/talc blend. In a foam extrusion apparatus, described below, 100 parts by weight of the PEI/talc blend were combined with 0.3 parts by weight methanol, and an amount of acetone that varied between examples and is specified in Table 2. The material throughput, excluding the contributions of methanol and acetone, was 165 kilograms of the PEI/talc blend per hour.

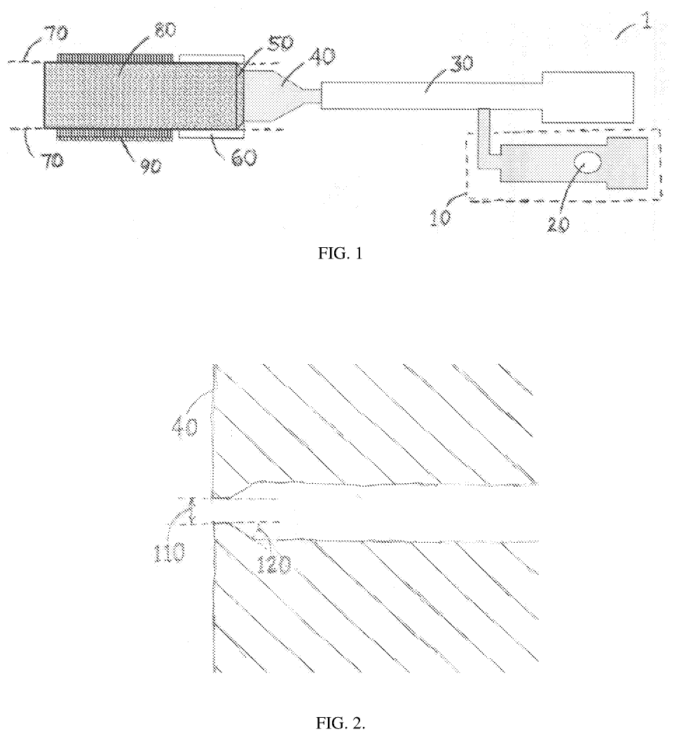

FIG. 1 is a schematic illustration of a foam extrusion apparatus 1. The foam extrusion apparatus 1 includes primary extruder 10, in which PEI/talc blend is melted and mixed with blowing agent (e.g., acetone and methanol) at melt temperatures up to about 390° C. to form a melt blend. The PEI/talc blend is added to primary extruder 10 via feed throat 20. Blowing agent is added to primary extruder 10 via a port (not shown) just downstream of feed throat 20. The melt blend produced in primary extruder 10 is transferred to secondary extruder 30, where it is cooled to a melt temperature of about 200° C. The cooled melt blend is then transferred to die 40, where expansion (foam formation) begins. On exiting die 40, the still-expanding foam 50 continues to expand until that expansion is constrained by calibrator plates 60 above and below the major plane of the foam (only the lower calibrator plate is shown in FIG. 1). The foam also expands to edges 70 parallel to the machine direction and within the plane of FIG. 1. After emerging from calibrator plates 60, the foam is fully expanded and in the form of foam board 80. Foam board 80 passes between a series of rollers 90 which pull the board through the line at a pre-determined speed known as the line speed (FIG. 1 shows only the set of rollers 90 below foam board 80). At the left end of FIG. 1, an arrow indicates the machine direction.

The extrusion equipment used for these examples was purchased from KrausMaffei Berstorff (Hannover, Germany). The internal diameter of the connection between secondary extruder 30 and die 40 was circular in cross section with a diameter of about 80 millimeters. FIG. 2 is a schematic illustration of a cross section of the outlet portion of die 40. Before exiting the die through an opening having height 110, the expanding material encounters a restriction characterized by die lip angle 120. In the present experiments, the die lip angle was about 31°, and the opening had a width of about 800 millimeters and a height of about 4 millimeters.

Four process parameters were varied: the dispersity of the polyetherimide, the acetone content of the pre-foamed composition, the die temperature, and the line speed. Dispersity, which is unitless, is the ratio of weight average molecular weight to number average molecular weight, each determined by gel permeation chromatography using polystyrene standards. Acetone content is the parts by weight of acetone per 100 parts by weight of the PEI/talc blend. Die melt temperature, expressed in units of degrees centigrade, is the melt temperature of the expandable composition within the die. Line speed, expressed in units of meters/minute, is the speed at which the foam board is pulled out of the foaming extruder.

A first set of experiments (Examples 1-4 in Table 2) utilized PEI 1 having a dispersity of 2.3. Acetone content, die temperature, and line speed were varied as specified in Table 2. Closed cell content was determined for the foam board produced in each set of process conditions. Closed cell content, which is calculated on a number basis and expressed in units of percent, was determined according to ASTM D6226-15 using an ACCUPYC™ II 1340 gas pycnometer from Micromeritics. Process variations and closed cell content values are summarized in Table 2. The results show that for each set of process conditions, the pre-foamed material containing a polyetherimide with a dispersity of 2.3 produced a foam with a low closed cell content in the range 13-25%. A second set of experiments (Examples 5-9 in Table 2) utilized PEI 2 with a dispersity of 3.4. Acetone content, die temperature, and line speed were varied. Mass flux ratio values were calculated as described above. Process variations and closed cell content values are summarized in Table 2. The results in Table 2 show that closed cell contents in the desired range of 80 to 100 percent were attained by Examples 8 and 9.

TABLE 2

| | Ex. 1 | Ex. 2 | Ex. 3 | Ex. 4 | Ex. 5 |
|---|---|---|---|---|---|
| Polyetherimide type | PEI 1 | PEI 1 | PEI 1 | PEI 1 | PEI 2 |
| Acetone Content (%) | 5.2 | 5.4 | 5.4 | 5.2 | 4.7 |
| Die Melt Temp. (° C.) | 195 | 208 | 213 | 200 | 190 |
| Line Speed (m/min) | 1.37 | 1.07 | 1.10 | 1.07 | 1.00 |
| Closed Cell Content (%) | 25 | 13 | 20 | 21 | 26 |
| Density (kg/m³) | 40.7 | 42.5 | 40.3 | 39.9 | 46.9 |
| Mass flux ratio | — | — | — | — | 0.052 |

| | Ex. 6 | Ex. 7 | Ex. 8 | Ex. 9 |
|---|---|---|---|---|
| Polyetherimide type | PEI 2 | PEI 2 | PEI 2 | PEI 2 |
| Acetone Content (%) | 5.4 | 4.7 | 5.4 | 5.3 |
| Die Melt Temp. (° C.) | 189 | 189 | 210 | 203 |
| Line Speed (m/min) | 0.81 | 0.74 | 1.10 | 1.06 |
| Closed Cell Content (%) | 34 | 75 | 93 | 100 |
| Density (kg/m³) | 48.7 | 45.3 | 42.7 | 38.9 |
| Mass flux ratio | 0.044 | 0.036 | 0.048 | 0.047 |

1. A polyetherimide-based foam, comprising:
96 to 99.8 parts by weight of a polyetherimide having a weight average molecular weight of 30,000 to 80,000 grams per mole and a dispersity of 2.7 to 4.5 determined by gel permeation chromatography using polystyrene standards; and
0.2 to 4 parts by weight of a nucleating agent;
wherein parts by weight are based on 100 parts by weight total of the polyetherimide and the nucleating agent;
wherein the polyetherimide-based foam has a density of 20 to 60 kilograms per meter³ determined at 23° C. according to ASTM D1622-14; and
wherein the polyetherimide-based foam has a closed cell content of 80 to 100 percent, determined according to ASTM D6226-15.

2. The polyetherimide-based foam of claim 1, wherein the polyetherimide comprises poly[2,2-bis(4-(3,4-dicarboxyphenoxy)phenyl)propane)-1,3-phenylene bisimide].

3. The polyetherimide-based foam of claim 1, wherein the nucleating agent comprises talc.

4. The polyetherimide-based foam of claim 1, having a closed cell content of 87 to 100 percent.

5. The polyetherimide-based foam of claim 1, wherein the polyetherimide has a complex viscosity of 4300 to 5300 Pascal-seconds, determined according to ASTM D4440-15 at 340° C. and an angular frequency of 1 radian/second.

6. The polyetherimide-based foam of claim 1,
wherein the polyetherimide-based foam comprises 98 to 99.5 parts by weight of the polyetherimide and 0.5 to 2 parts by weight of the nucleating agent;
wherein the polyetherimide has a weight average molecular weight of 55,000 to 75,000 grams per mole and a dispersity of 2.8 to 4.3;
wherein the nucleating agent comprises talc; and
wherein the polyetherimide-based foam has a density of 30 to 50 kilograms per meter³, and a closed cell content of 87 to 100 percent.

7. An article comprising the polyetherimide-based foam of claim 1.

8. The article of claim 7, comprising the polyetherimide-based foam of claim 6.

9. The article of claim 7 or 8, wherein the article is aerospace interior paneling.

10. An expandable polyetherimide composition, comprising:
96 to 99.8 parts by weight of a polyetherimide having a weight average molecular weight of 30,000 to 80,000 grams per mole and a dispersity of 2.7 to 4.5, determined by gel permeation chromatography using polystyrene standards;
0.2 to 4 parts by weight of a nucleating agent; and
4.1 to 7 parts by weight of a blowing agent comprising
4 to 6 parts by weight acetone and
0.1 to 1 part by weight methanol;
wherein all parts by weight are based on 100 parts by weight total of the polyetherimide and the nucleating agent.

11. The expandable polyetherimide composition of claim 10,
wherein the expandable polyetherimide composition comprises
98 to 99.5 parts by weight of the polyetherimide,
0.5 to 2 parts by weight of the nucleating agent, and
4.65 to 6.1 parts by weight of the blowing agent comprising
4.5 to 5.5 parts by weight acetone and
0.15 to 0.6 parts by weight methanol;
wherein the polyetherimide has a weight average molecular weight of 55,000 to 75,000 grams per mole and a dispersity of 2.8 to 4.3; and
wherein the nucleating agent comprises talc.

12. A method of forming a polyetherimide-based foam, comprising:
forming an expandable composition by melt blending
96 to 99.8 parts by weight of a polyetherimide having a weight average molecular weight of 30,000 to 80,000 grams per mole and a dispersity of 2.7 to 4.5, determined by gel permeation chromatography using polystyrene standards,
0.2 to 4 parts by weight of a nucleating agent, and
4.1 to 7 parts by weight of a blowing agent comprising
4 to 6 parts by weight acetone and
0.1 to 1 part by weight methanol,
wherein all parts by weight are based on 100 parts by weight total of the polyetherimide and the nucleating agent; and
extruding the expandable composition through a die to form a polyetherimide-based foam having a density of 20 to 60 kilograms per meter³ determined at 23° C. according to ASTM D1622-14, and a closed cell content of 80 to 100 percent, determined according to ASTM D6226-15; wherein the extruding comprises maintaining a die melt temperature of 195 to 230° C., and a mass flux ratio of 0.035 to 0.065, wherein mass flux ratio is defined as a ratio of mass flux after the die to mass flux before the die.

13. The method of claim 12,
wherein the expandable composition comprises
98 to 99.5 parts by weight of the polyetherimide,
0.5 to 2 parts by weight of the nucleating agent, and
4.65 to 6.1 parts by weight of the blowing agent comprising
4.5 to 5.5 parts by weight acetone and
0.15 to 0.6 parts by weight methanol;
wherein the polyetherimide has a weight average molecular weight of 55,000 to 75,000 grams per mole and a dispersity of 2.8 to 4.3;
wherein the nucleating agent comprises talc; and
wherein the polyetherimide-based foam has a density of 30 to 50 kilograms per meter³, and a closed cell content of 87 to 100 percent.
